(19) United States
(12) Patent Application Publication
(10) Pub. No.: US 2014/0083548 A1
(43) Pub. Date: Mar. 27, 2014

(54) LIQUID SUCTION DEVICE COMPRISING A TIP REDUCING THE FORMATION OF A SUCTION VORTEX

(71) Applicants: Romain Plante, Avon (FR); Louis Bettega, Boucheporn (FR); Frank Louis, Folschville (FR)

(72) Inventors: Romain Plante, Avon (FR); Louis Bettega, Boucheporn (FR); Frank Louis, Folschville (FR)

(73) Assignee: SNECMA, Paris (FR)

(21) Appl. No.: 14/118,074

(22) PCT Filed: May 25, 2012
(86) PCT No.: PCT/FR2012/051185

§ 371 Date: Nov. 15, 2013

(30) Foreign Application Priority Data
May 27, 2011 (FR) 11 54650

(51) Int. Cl. F16L 35/00

(52) U.S. Cl. CPC F16L 35/005
USPC 138/109

(57) ABSTRACT

A device for suctioning a liquid contained in a vessel, that includes a take-up tube that is received in the vessel such that a bottom end of the section is submerged in the liquid. The bottom end of the take-up tube is extended downward by a rotationally symmetrical tip which has a main substantially vertical axis open downward and which includes an outer radial collar.

### TECHNICAL FIELD

The invention proposes a liquid suction device comprising a tip that reduces the formation of a suction vortex in the liquid.

The invention proposes more particularly a suction device adapted to a viscous liquid such as a resin supplying equipment for creating parts made of composite material.

### PRIOR ART

In equipment for creating parts made of composite material, the conditions for injecting the resin are particularly important to prevent the appearance of air bubbles in the part.

Before it is injected, the resin is subjected to a degassing which consists in removing through evaporation the solvents present in the resin, which could be detrimental to the quality of the composite material.

This degassing operation is carried out by placing the volume of resin that is going to be injected into a vessel. The internal volume of the vessel is then pressurised in order to carry out the injection operation.

The pressure and temperature conditions of the resin have an impact on the flow conditions of the resin during its injection.

In particular, a high temperature of the resin allows the fluidity of the latter to be increased and to facilitate its flow. However, an excessive temperature of the resin risks provoking a phenomenon on exothermicity, i.e. the resin retains its heat, which increases progressively to an excessive temperature that can cause the resin to explode.

The resin is thus brought to an optimum temperature for which the fluidity of the resin is reduced.

Another constraint imposed on the injection installation consists in that the resin must be injected during a limited period of time after which the resin can no longer be used.

For this, the injection pressure is increased in order to increase the flow of resin so that the resin is injected within the required period of time.

The transfer of the resin from the vessel to the injection device takes place in a known manner via a take-up tube which is plunged into the resin. The end of the take-up tube is located in the vicinity of the bottom of the vessel, in order to allow for the suction of a maximum amount of resin.

During the suction of the resin, due to the high pressure and the substantial flow, a vortex is produced which can reach the bottom end of the take-up tube. Air is then suctioned with the resin, which can be detrimental to the quality of the material made using the resin.

The invention has for purpose to propose a device for suctioning a liquid, in particular a resin, which makes it possible to reduce the formation of this vortex.

### DESCRIPTION OF THE INVENTION

The main object of the invention is a device for suctioning a liquid contained in a vessel, that comprises a take-up tube that is received in the vessel in such a way that a bottom end of said section is submerged in the liquid, of which the bottom end of the take-up tube is extended downward by a rotationally symmetrical tip which has a main substantially vertical axis open downward and which comprises an outer radial collar, and of which the tip comprises a tubular body that vertically extends downward the bottom end of the take-up tube and the collar extends radially outward from the bottom end of the tubular body, characterised in that the collar comprises grooves radial in relation to the main axis of the tip which are carried out in a bottom end face of the collar.

The adding of a tip comprising a collar makes it possible to prevent the vortex from reaching the orifice through which the resin is suctioned, thus preventing air from being suctioned.

Preferably, each groove exits onto the peripheral external edge of the collar.

Preferably, the section of each groove is determined in such a way that the sum of the sections of all of the grooves is substantially equal to the section of the take-up tube.

Preferably, the bottom face of the collar comprises a central cavity that extends the mouth of the tip downward, and wherein the grooves exit radially inward.

Preferably, the cavity is generally circular coaxial to the tubular body and has a diameter greater than or equal to the inner diameter of the tubular body.

Preferably, the tip is arranged vertically in the vicinity of the bottom of the vessel.

Preferably, the collar is pressing against the bottom of the vessel.

### BRIEF DESCRIPTION OF THE DRAWINGS

Other characteristics and advantages of the invention shall appear when reading the following detailed description for the understanding of which reference will be made to the annexed drawings wherein:

FIG. 1 diagrammatically shows the suction device comprising a tip according to the invention;

FIG. 2 diagrammatically shows as a perspective bottom view of a tip carried out according to the invention;

FIG. 3 is an axial cross-section of the tip shown in FIG. 2;

FIG. 4 is a view at the end of the tip shown in FIG. 2.

### DETAILED DESCRIPTION OF PARTICULAR EMBODIMENTS

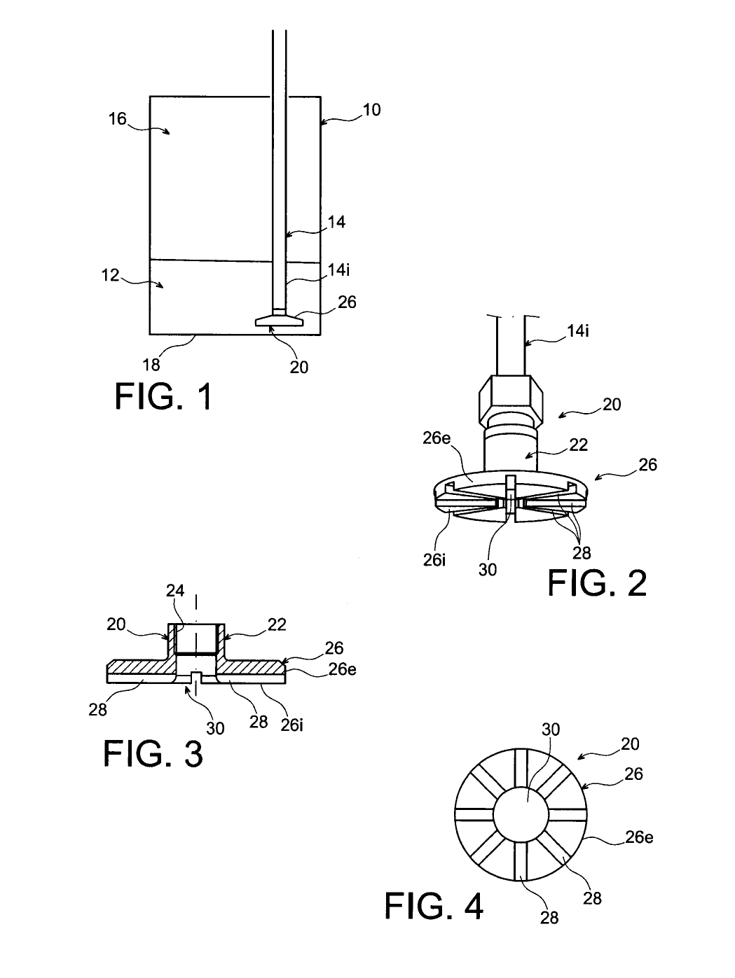

FIG. 1 shows a vessel 10 containing a certain quantity of resin 12 intended to be injected to form a part made of composite material.

The quantity of resin 12 received in the vessel 10 is predefined in such a way that all of this quantity of resin will be used during the injection operation.

The overall volume of the vessel 10 is greater than the volume of resin, so that the resin 12 can undergo a degassing phase wherein gases contained in the resin 12 are removed to the volume of air 16 located in the vessel 10, above the resin 12.

A take-up tube 14 is plunged into the vessel 10, in order to take the resin 12 and convey it to a station for injecting the resin (not shown).

The resin 12 is taken via the application of a pressure to the volume of air 16 located above the resin 12, which forces the resin 12 to flow into the take-up tube 14 in order to be brought to a station for injecting the resin 12.

The take-up tube 14 comprises a bottom end 14i which is located vertically in the vicinity of the bottom 18 of the vessel 10.

The bottom end 14i of the take-up tube 14 carries a rotationally symmetrical tip 20 carried out in such a way as to reduce the formation of a vortex that can cause the suction of air with the resin 12.

As can be seen in more detail in FIGS. 2, 3 and 4, the tip 20 comprises a tubular body 22 with a main vertical axis that extends downward the bottom end 14i of the take-up tube 14.

The tubular body 22 is fastened to the bottom end 14i of the take-up tube 14, here via screwing. It comprises for this purpose a threading 24 that cooperates with a complementary threading of the bottom end 14i of the take-up tube 14.

The tip 20 also comprises a horizontal collar 26 that extends radially outward from the bottom end of the tubular body 22.

This collar 26 makes it possible to separate the mouth of the tubular body 22, located generally under the collar 26, through which the resin 12 is suctioned, from the outside air, and more mainly from the vortex that can form above the collar 26.

According to a preferred embodiment of the tip 20, the collar 26 comprises radial grooves 28 which are carried out in the bottom horizontal face 26i of the collar 26.

Here, the tip 20 comprises eight radial grooves 28. It is understood that the invention is not limited to this number of grooves, which can be higher or lower.

Each groove 28 is open downward and exits radially outward on the outer cylindrical edge 26e of the collar 26.

Also, the collar 26 comprises a generally circular-shaped central cavity 30 centred on the main vertical axis of the tip 20, extending the mouth of the tubular body 22, wherein the grooves 28 exit radially at their inside ends.

Thus, the suctioned resin flows in the grooves 28 and converges towards the central cavity 30.

The grooves 28 make it possible to take the resin at several different locations, which reduces the possibility of the formation of a vortex of resin 12 around the tip 20.

According to the embodiment shown in FIG. 1, the tip 20 is arranged at a vertical distance from the bottom 18 of the vessel 10, which allows the resin 12 to circulate under the bottom face 26i of the collar 26, so that a maximum amount of resin reaches the central cavity 30.

However, as was mentioned hereinabove, the vessel is filled with a predefined quantity of resin 12, corresponding to the quantity of resin 12 that will be injected in order to form a part made of composite material.

As such, if the tip 20 is placed vertically at a distance from the bottom 18 of the vessel 10, a certain quantity of resin cannot be suctioned, and will therefore be lost.

According to a preferred embodiment, the tip 20 is arranged in such a way that it is in contact with the bottom 18 of the vessel 10.

As was mentioned hereinabove, each groove 28 is open downward, which makes it possible to suction the resin 12 which is on the bottom 18 of the vessel. Also, so that the flow of resin 12 is optimal, the grooves 28 are carried out in such a way that the sum of the sections of passage of all of the grooves is at least equal to the section of the take-up tube 14.

Preferably, this sum of sections is greater than the section of the take-up tube 14, for example in order to offset the load losses induced by the shape of the grooves 28.

According to the embodiment shown in the figures, the diameter of the central cavity 30 of the collar 26 is substantially equal to the internal section of the cylindrical body 22 and of the take-up tube 14.

According to an alternative embodiment not shown, the diameter of the central cavity 30 is greater than the inner diameter of the cylindrical body 22.

The central cavity 30 thus forms an intermediary chamber wherein the grooves 28 exit.

1-7. (canceled)

8. A device for suctioning a liquid contained in a vessel, the device comprising:
a take-up tube that is received in the vessel such that a bottom end of a section is submerged in the liquid,
wherein the bottom end of the take-up tube is extended downward by a rotationally symmetrical tip which has a main substantially vertical axis open downward and which comprises an outer radial collar, and
wherein the tip comprises a tubular body that vertically extends downward the bottom end of the take-up tube, and wherein the collar extends radially outward from the bottom end of the tubular body,
wherein the collar comprises grooves radial in relation to the main substantially vertical axis of the tip which are carried out in a bottom face of the collar.

9. A device for suctioning according to claim 8, wherein each groove exits onto an peripheral external edge of the collar.

10. A device for suctioning according to claim 8, wherein the section of each groove is determined such that the sum of sections of all of the grooves is substantially equal to the section of the take-up tube.

11. A device for suctioning according to claim 8, wherein the bottom face of the collar comprises a central cavity that extends a mouth of the tip downward, and wherein the grooves exit radially inward.

12. A device for suctioning according to claim 11, wherein the cavity is generally circular coaxial to the tubular body and has a diameter greater than or equal to an inner diameter of the tubular body.

13. A device for suctioning according to claim 8, wherein the tip is arranged vertically in a vicinity of a bottom of the vessel.

14. A device for suctioning according to claim 8, wherein the collar presses against a bottom of the vessel.
